(19) United States
(12) Patent Application Publication
(10) Pub. No.: US 2019/0301614 A1
(43) Pub. Date: Oct. 3, 2019

(54) Groove Ring Seal And Method For Production Thereof

(71) Applicant: MAN ENERGY SOLUTIONS SE, Augsburg (DE)

(72) Inventor: Eike HYLLA, Berlin (DE)

(21) Appl. No.: 16/306,279

(22) PCT Filed: Apr. 7, 2017
(86) PCT No.: PCT/EP2017/058346

§ 371 Date: Nov. 30, 2018

(30) Foreign Application Priority Data
Jun. 3, 2016 (DE) 10 2016 110 268.7

(51) Int. Cl. F16J 15/3236

(52) U.S. Cl. CPC F16J 15/3236

(57) ABSTRACT

A groove ring seal, having an annular main seal body made of a thermoplastic plastic and has a U-shaped cross-sectional contour having scaling portions that define a groove together with a connecting portion of the main seal body extending between the scaling portions. The groove ring seal also has at least one support element for the sealing portions. Each support element is designed as an integral component of the main seal body.

### CROSS REFERENCE TO RELATED APPLICATIONS

This is a U.S. national stage of application No. PCT/EP2017/058346, filed on Apr. 7, 2017. Priority is claimed on German Application No. DE102016110268.7, filed Jun. 3, 2016, the content of which is/are incorporated here by reference.

### BACKGROUND OF THE INVENTION

### 1. Field of the Invention

The invention relates to a groove ring seal and to a method for producing such a groove ring seal.

### 2. Description of the Prior Art

From DE 198 15 442 A1 a groove ring seal having an annular main seal body and a support element as shaft seal or rod seal is known. In the radial section, the main seal body has a U-shaped cross section with sealing portions extending concentrically relative to one another, wherein the sealing portions together with a connecting portion extending between the sealing portions define a groove. According to DE 198 15 442 A1 the support element, which subjects the sealing portions to preload, is formed as annular spring.

From DE 10 2009 016 552 A1 an annular sealing element of a fluor-containing polymer material, namely of PTFE (polytetrafluroethylene) is known. PTFE is a sealing material that is chemically resistant to aggressive media. In particular when the annular main seal body of a groove ring seal is produced from such a PTFE material, the same is subjected to preload via a support element formed as metallic spring element according to the prior art, wherein here there is the disadvantage that the spring steel of the spring element is subject to a corrosion in contact with aggressive media. For this reason it is known from practice to coat, in particular gold-plate metallic spring elements of groove ring seals serving as support elements, in order to protect the same from corrosion. However this is expensive and time-consuming.

### SUMMARY OF THE INVENTION

One aspect of the present invention is based on creating a new type of groove ring seal and a method for producing such a groove ring seal.

According to one aspect of the invention, the or each support element is formed as an integral component of the main seal body.

In the case of the groove ring seal according to the invention, the or each support element, via which the sealing portions of the main seal body are subjected to a preload, are formed as an integral component of the main seal body. The metallic spring element is no longer required.

According to an advantageous further development, the or each support element consists of the thermoplastic plastic of the main seal body, wherein the thermoplastic plastic is preferentially a fluor-containing polymer material, in particular a PTFE material. In particular when the respective support element consists of the thermoplastic plastic of the main seal body, the same is resistant to aggressive media.

According to an advantageous further development of the invention, the or each support element is formed as a curved supporting arch, which extends between the sealing portions of the main seal body which preferentially extend concentrically to one another. Preferentially, the respective supporting arch has a thickness which amounts to maximally 5°, preferably maximally 4°, particularly preferably maximally 3° of the circumferential extension of the main seal body. By way of such support elements, the sealing portions of the main seal body can be subjected to a suitable preload in a particularly simple and advantageous manner.

### BRIEF DESCRIPTION OF THE DRAWINGS

Preferred further developments of the invention are obtained from the subclaims and the following description. Exemplary embodiments of the invention are explained in more detail by way of the drawing without being restricted to this. There it shows:

FIG. 1: is a cross section through a first groove ring seal according to the invention;

FIG. 2: is a detail of the groove ring seal of FIG. 1;

FIG. 3: is a cross section through a second groove ring seal according to the invention;

FIG. 4: is a detail of the groove ring seal of FIG. 3;

FIG. 5: is a cross section through a third groove ring seal according to the invention; and

FIG. 6: is a detail of the groove ring seal of FIG. 5.

### DETAILED DESCRIPTION OF THE PRESENTLY PREFERRED EMBODIMENTS

The invention relates to a groove ring seal.

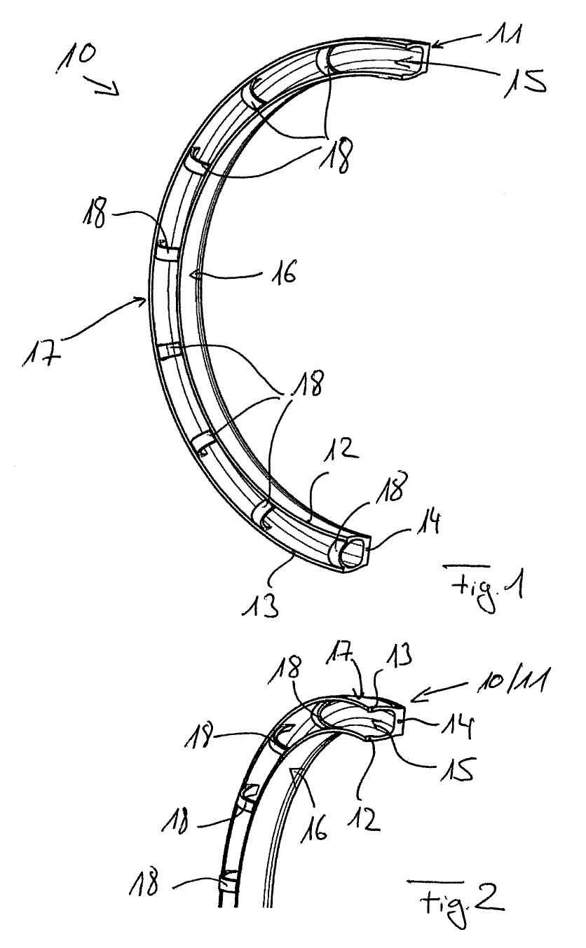

FIGS. 1 and 2 show details of a first groove ring seal 10 according to the invention. The groove ring seal 10 comprises an annular main seal body 11, which seen in the radial section has a U-shaped cross-sectional contour. This main seal body 11 comprises sealing portions 12, 13, which preferentially extend concentrically to one another, and which are connected to one another on one side via a connecting portion 14. On the side located opposite the connecting portion 14, the main seal body 11 is designed open thereby forming a groove 15. Together with the connecting portion 14 of the main seal body 11 extending inbetween, the sealing portions 12, 13 of the main seal body 11 define the cross-sectional contour of the main seal body 11 that is U-shaped in the radial section.

Outer sealing faces 16, 17 of the sealing portions 12, 13 facing away from the groove 15 form sealing faces of the groove ring seal 10, which when a corresponding pressure is built-up in the groove 15, are pressed against sealing faces of a component which are not shown, in which the groove ring seal 10 is accommodated. Here, a radially inner sealing face 16 of a radially inner sealing portion 12 is pressed radially to the inside, whereas a radially outer sealing face 17 of a radially outer sealing portion 13 is pressed radially to the outside.

The groove ring seal 10, namely the sealing portions 12, 13 of the main seal body of the groove ring seal 10 are subjected to a preload by support elements 18. These support elements 18 are formed as an integral component of the main seal body 11. The main seal body 11 and the integral support elements 18 of the same are produced from a thermoplastic plastic, preferentially from a fluor-containing polymer material, particularly preferably of a PTFE (polytetrofluroethylene material).

Such a groove ring seal 10 can be employed in particular when the same comes into contact with aggressive media. Although the embodiment of the groove ring seal from a PTFE material is preferred, the same can be alternatively produced also from a POM material or a PA material. Here, the main seal body 11 and the integral support elements 18 of the same are always produced from the same thermoplastic plastic.

In the exemplary embodiment of FIGS. 1 and 2, the support elements 18 are designed as curved supporting arches, which in defined circumferential positions of the main seal body 11, extend between the sealing portions 12, 13 of the main seal body 11. In FIGS. 1 and 2, each of the supporting arches is formed as supporting arch curved convexly out of the groove 15 and in each case extends approximately in the radial direction.

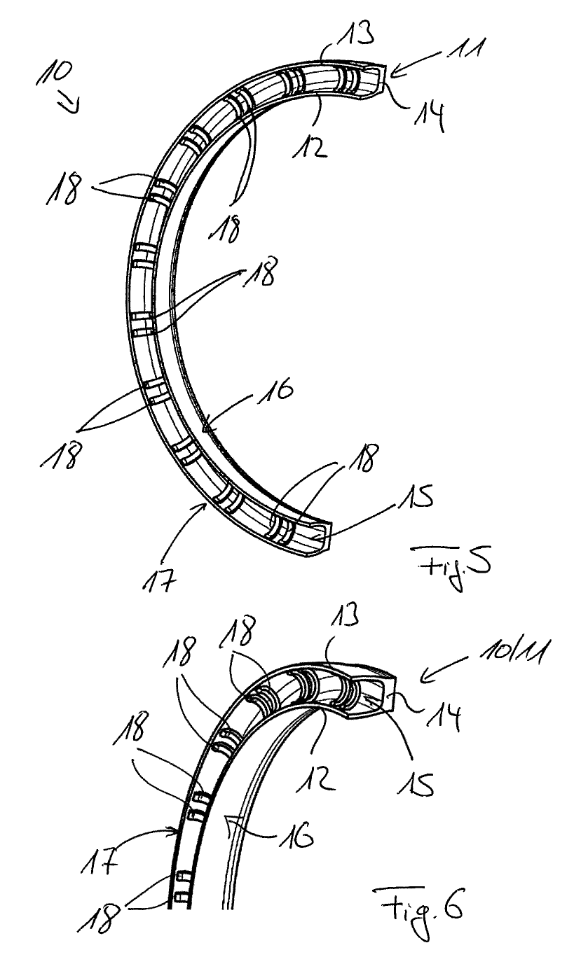

It is pointed out here that in contrast with the exemplary embodiment of FIGS. 1 and 2 it is also possible that the support elements are formed as supporting arches which are concavely curved into the groove 15, which in turn extend in the radial direction. Refer to the exemplary embodiment of FIGS. 5 and 6 in this regard.

It is likewise possible that on the one hand supporting arches curved out of the groove 15 and supporting arches which on the other hand are concavely curved into the groove are employed as support elements 18 combined with one another.

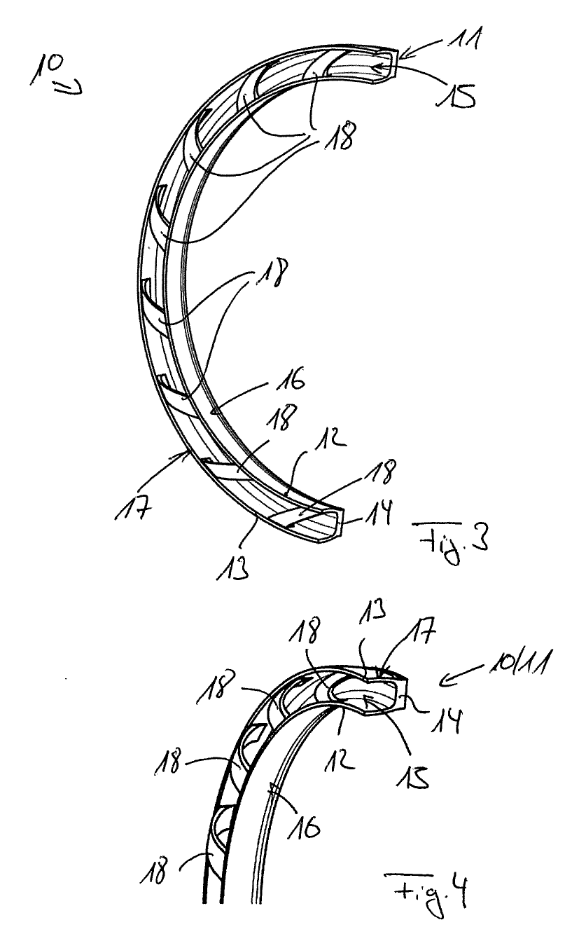

In the exemplary embodiment of FIGS. 1 and 2, the support elements 18 extend in the radial direction, and the same are not set at an incline relative to the radial direction. In contrast with this it is possible that the respective support element 18 includes an angle with the radial direction, i.e. is set at an incline relative to the radial direction, this angle amounting to maximally 45°, preferably maximally 30°, particularly preferably maximally 20°. Refer to the exemplary embodiment of FIGS. 3 and 4 in this regard. Here it is possible that the support elements 18 include with the radial direction an angle between 5° and 45°, preferably an angle between 10° and 30°, particularly preferably an angle between 10° and 20°.

It is also possible to employ on the one hand support elements 18 extending in the radial direction and on the other hand support elements 18 which are set at an incline relative to the radial direction, combined with one another.

As already explained, multiple support elements 18 are preferentially distributed over the circumference of the main seal body 11, wherein this distribution of the support elements 18, seen in the circumferential direction, can be equidistant (refer to the exemplary embodiment of FIG. 1, 2 and of FIG. 3, 4 in this regard) or not equidistant (refer to the exemplary embodiment of FIG. 5, 6 in this regard).

The respective support element 18 has a defined thickness, wherein this thickness is maximally 5°, particularly preferably maximally 4°, particularly preferably maximally 3° of the circumferential extension of the main seal body 10. Here, this circumferential extension relates to the circumferential extension of the radially inner sealing portion 12 or to the circumferential extension of the radially outer sealing portion 13 of the main seal body 11.

The basic body of the groove ring seal 10 of the annular main seal body 11 and the integral support elements 18 can be produced by compression moulding, sintering, or by 3D printing. The selection of the appropriate production method depends on the thermoplastic plastic, of which the main seal body 11 and the integral support elements of the same consist. In particular when a PTFE material is utilised, preferentially compression moulding or sintering is used as production method.

Preferentially after the injection moulding or the 3D printing, the groove ring seal is subjected to a reworking in the region of the sealing faces 16, 17 of the sealing portions 12, 13, in particular by turning, in order to provide sealing faces of the required quality.

The invention proposes for the first time a groove ring seal 10, with which support elements 18, which serves for preloading the sealing portions 12, 13 of the main seal body 11 of the groove ring seal 10, are an integral component of the main seal body 11 and are produced from the same thermoplastic material as the main seal body 11. Particularly preferably, a PTFE material is employed as material, which can be easily and reliably processed in particular by compression moulding or sintering.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-14. (canceled)

15. A groove ring seal, comprising:
an annular main seal body of a thermoplastic plastic, which has a U-shaped cross-sectional contour having:
first and second sealing portions, and
a connecting portion extending between the first and second sealing portions, wherein the first and second sealing portions and the connecting portion define a groove; and
at least one support element for the first and second sealing portions formed as integral component of the annular main seal body.

16. The groove ring seal according to claim 15, wherein the at least one support element consists of the thermoplastic plastic of the annular main seal body.

17. The groove ring seal according to claim 15, wherein the thermoplastic plastic is a fluor-containing polymer material.

18. The groove ring seal according to claim 15, wherein the at least one support element is formed as a curved supporting arch, which extends between the first and second sealing portions of the annular main seal body.

19. The groove ring seal according to claim 18, wherein the at least one support element is formed as a supporting arch convexly curved out of the groove.

20. The groove ring seal according to claim 18, wherein the at least one support element is formed as supporting arch concavely curved into the groove.

21. The groove ring seal according to claim 15, wherein the at least one support element extends in a radial direction.

22. The groove ring seal according to claim 15, wherein the at least one support element is set at an incline relative to a radial direction.

23. The groove ring seal according to claim 22, wherein the respective support element includes with the radial direction an angle of maximally at least one of 45°, 30°, and 20°.

24. The groove ring seal according to claim 15, wherein the respective support element has a thickness which is maximally at least one of 5°, 4°, and 3° of a circumferential extension of the annular main seal body.

25. The groove ring seal according to claim 15, wherein over a circumference of the annular main seal body, a plurality of support elements are distributed spaced from one another.

26. A method for producing a groove ring seal having an annular main seal body of a thermoplastic plastic, which has a U-shaped cross-sectional contour having first and second sealing portions, and a connecting portion extending between the first and second sealing portions, wherein the first and second sealing portions and the connecting portion define a groove; and at least one support element for the first and second sealing portions formed as integral component of the annular main seal body, the method comprising:
providing a thermoplastic plastic
produced the groove ring seal by one of compression moulding, sintering, and 3D printing.

27. The method according to claim 26, further comprising:
reworking in a region of sealing faces of the first and second sealing portions of the annular main seal body, in particular by turning.

28. The method according to claim 27, wherein the reworking is turning.

29. The groove ring seal according to claim 17, wherein the thermoplastic plastic is a PTFE material, wherein the PTFE material is provided with fillers to improve material characteristics.
